(19) United States
(12) Patent Application Publication
(10) Pub. No.: US 2011/0258980 A1
(43) Pub. Date: Oct. 27, 2011

(54) PROCESS FOR CO-GENERATION OF MECHANICAL-ELECTRICAL ENERGY AND HEAT

(75) Inventors: Jean Louis AMBROSINO, Ternay (FR); Florent Guillou, Ternay (FR); Fabrice Giroudiere, Orlienas (FR)

(73) Assignee: IFP ENERGIES NOUVELLES, Rueil-Malmaison Cedex (FR)

(21) Appl. No.: 13/092,401

(22) Filed: Apr. 22, 2011

(30) Foreign Application Priority Data
Apr. 23, 2010 (FR) 10/01.754

(51) Int. Cl. F02G 3/00

(52) U.S. Cl. 60/39.5

(57) ABSTRACT

This invention relates to a process for the production of electrical or mechanical energy and heat from a liquid fuel that comprises:
A stage for producing a synthetic gas by vaporeforming in a vaporeforming unit (6),
A stage for dehydrating synthetic gas by condensation of the water that is contained in the gas,
A stage for transforming dehydrated synthetic gas into electrical energy and into heat,
A stage for recycling unconverted synthetic gas to the synthetic gas transformation stage to a hydrogen burner (16) that supplies energy to the vaporeforming unit (6),
A stage for recycling the condensed water that is obtained during the dehydration of the synthetic gas to the vaporeforming unit (6).

This invention relates to the field of the production of heat and mechanical or electrical energy and more particularly a process for co-generation of heat and independent electrical energy in water.

The production of heat and mechanical or electrical energy in a co-generation system is known. These systems contribute in general to the enhancement of energy efficiency of the processes. Co-generation systems have multiple operating principles, and among them the schemes that integrate a fuel cell, as a unit for converting the gas that is produced into electrical or mechanical energy, are particularly notable. Actually, the fuel cells make it possible to generate heat and electricity in a single piece of equipment. The use of this type of equipment in installations for co-generating electricity and heat makes it necessary to provide to the system:
Fuel for the cell, most often hydrogen, pure or in a mixture,
Oxidizer, most often oxygen, pure or in a mixture,
Water, in the most common case fuel cells with polymer membrane electrolytes.

When these installations are implanted in zones that have the advantage of having well-developed transport, power and utilities networks, the problem that is posed comes from the fact that the cost of electricity in these zones is generally low and consequently the profitability and the viability of such installations are not ensured. It is therefore necessary to find solutions for implanting these installations where the transport, power and utilities networks are not installed and where the price of electricity is higher. Several specific constraints of autonomy should be taken into account during the use of these installations in zones without developed transport, power and utilities networks.

The Supply of Fuel:

A solution for the fuel supply, in the case where a fuel cell is used, is to supply the fuel cell directly with pure hydrogen from a network or a tank. In the case of an isolated application, i.e., in the case where the installation is the only installation that requires a supply of hydrogen, this is necessarily done by tank. However, at present, the supply of a gas such as hydrogen in this form is complex and expensive regardless of whether it is in liquefied form or at a very high pressure. This solution is therefore only considered for niche applications where the cost of the energy is not the determining factor such as, for example, space applications. Another solution consists in using a methanol cell. Methanol is an easily transportable liquid fuel that can be used directly by the cell. The drawback of these methanol cells is their low power and the toxicity of their fuel, which confines them to low-power applications such as telephones or portable computers. Finally, another solution is to maintain the use of a fuel cell that is supplied with hydrogen but whose hydrogen is obtained from a fuel. Numerous solutions exist that use methane, but with the latter being gaseous, its use in an isolated environment is difficult for reasons of transport and storage.

The Supply of Oxidizer:

The supply of oxidizer can also be done in different ways. In the case of hydrogen fuel cells, the oxidizer that is used is oxygen. The latter can be provided in pure form, but as for hydrogen, the problem of transport and storage remains. The solution that is most commonly used and that is compatible with an application in an isolated environment is the use of oxygen of the air.

The Supply of Water:

Water is necessary to the proper operation of numerous fuel cells and in particular in the cells whose electrolyte consists of a polymer member (PEM), whereby water facilitates the transport of reactive radicals there. In the case of an isolated application, it is not possible, for economic reasons, to use a connection to a water source, regardless of the cooling water or the purified water that can be used directly by the cell. Theoretical studies have shown that it was possible to recycle the water that is produced by the cell in the case of spatial applications, methanol cells or else PEM-type cells with or without the associated production of hydrogen.

The purpose of the solutions that are currently used for the recycling of water or fuel that is not used is either to dispense consumables for saving energy or to dispense energy to save consumables. This is reflected by, for example, a solution of recycling hydrogen fuel that is not used by the fuel cell for enhancing its autonomy, whereby the transport of this fuel is ensured by the recycled vapor as the patent application JP 2008004468 describes it. The existing solutions that relate to water are limited to the recycling of the water in the cell outlet. The recycling can be done either by cooling only with air (described in the patent application US 2008226962) or by using a cooling water network (described in the patent application US 2006257699), which makes it possible to be self-sufficient in purified water but not in cooling water, or by recommending the recycling of the water at the cell outlet (described in the patent applications US 2008187800 and US 2008187789).

In the case of the production of fuel by reforming of a liquid hydrocarbon, the most used technique is the vapor reforming, whether the operation is or is not autothermal. This stage also requires a large quantity of water. In most of the industrial installations that operate continuously, this purified water is provided by a transport network. The cooling with air to condense the water of the vapor phase imposes limits, however. Actually, from an energy standpoint, it generally comprises a ventilation device of the radiator that is the energy consumer, and from a thermal standpoint, its efficiency is limited by the temperature of the ambient air. In the case of an isolated application, the use of such an installation is, moreover, very expensive in terms of equipment.

This invention therefore has as its object to remedy one or more of the drawbacks of the prior art by proposing a device for co-generation of mechanical or electrical energy and heat associating a carbon or hydrocarbon fuel reformer with a unit for converting gas that is produced into electrical or mechanical energy, whereby said device can operate independently in terms of water supply and in an isolated environment. This association also makes it possible to increase the thermal yield of the co-generation relative to the devices of the prior art.

For this purpose, this invention proposes a process for the production of electrical or mechanical energy and heat from a liquid fuel that comprises:
A stage for producing a synthetic gas by vaporeforming in a vaporeforming unit that uses liquid fuel and water, the heat that is necessary to this stage being provided by a hydrogen burner and by the synthetic gas that is produced,
A stage for dehydrating synthetic gas by condensation of the water that is contained in the gas,
A stage for transforming dehydrated synthetic gas into electrical energy and into heat,
A stage for recycling unconverted synthetic gas to the synthetic gas transformation stage to a hydrogen burner that supplies energy to the vaporeforming unit,
A stage for recycling the condensed water that is obtained during the dehydration of the synthetic gas to the vaporeforming unit.

According to an embodiment of the invention, the stage for transforming the synthetic gas produces an oxygen-depleted gaseous effluent that is condensed to obtain water.

According to an embodiment of the invention, the water that is obtained by condensation of the oxygen-depleted gaseous effluent is recycled to the vaporeforming unit.

According to an embodiment of the invention, the burner produces a gaseous effluent that is condensed to obtain water.

According to an embodiment of the invention, the water that is obtained by condensation of the gaseous effluent is recycled to the vaporeforming unit.

According to an embodiment of the invention, the dehydration stage is implemented by a cooling-tower system.

According to an embodiment of the invention, the process comprises a stage for purifying synthetic gas that is obtained in the vaporeforming stage.

According to an embodiment of the invention, the stage for purifying the synthetic gas comprises:
A high-temperature carbon monoxide to water conversion reaction,
A low-temperature carbon monoxide to water conversion reaction,
At least a first preferred oxidation stage of the carbon monoxide that is contained in the synthetic gas into carbon dioxide.

According to one embodiment of the invention, the purification stage comprises a second preferred stage for oxidation of the carbon monoxide that is contained in the synthetic gas into carbon dioxide.

According to an embodiment of the invention, the stage for transforming purified synthetic gas is implemented with a fuel cell.

According to an embodiment of the invention, the stage for dehydrating synthetic gas is preceded by a stage for cooling the synthetic gas.

According to an embodiment of the invention, the cooling stage is implemented in two stages:
A first stage at the level of a heat exchanger by the dehydrated synthetic gas, circulating in a pipe that comes from a flash reactor,
A second stage at the level of another heat exchanger by a fluid that circulates in a pipe that comes from the secondary cooling circuit.

According to an embodiment of the invention, the process comprises a stage for cooling the synthetic gas that is produced between the first and the second preferred oxidation stage of carbon monoxide contained in the synthetic gas into carbon dioxide.

According to an embodiment of the invention, the synthetic gas that is obtained from the high-temperature carbon monoxide to water conversion reaction is cooled, at the level of a heat exchanger, by an effluent that circulates in a pipe that comes from another heat exchanger to be under the conditions of the low-temperature carbon monoxide to water conversion reaction.

According to an embodiment of the invention, the synthetic gas that is obtained from the low-temperature carbon monoxide to water conversion reaction is cooled, at the level of a heat exchanger, by a hot fluid that circulates in a second pipe that comes from the secondary cooling circuit.

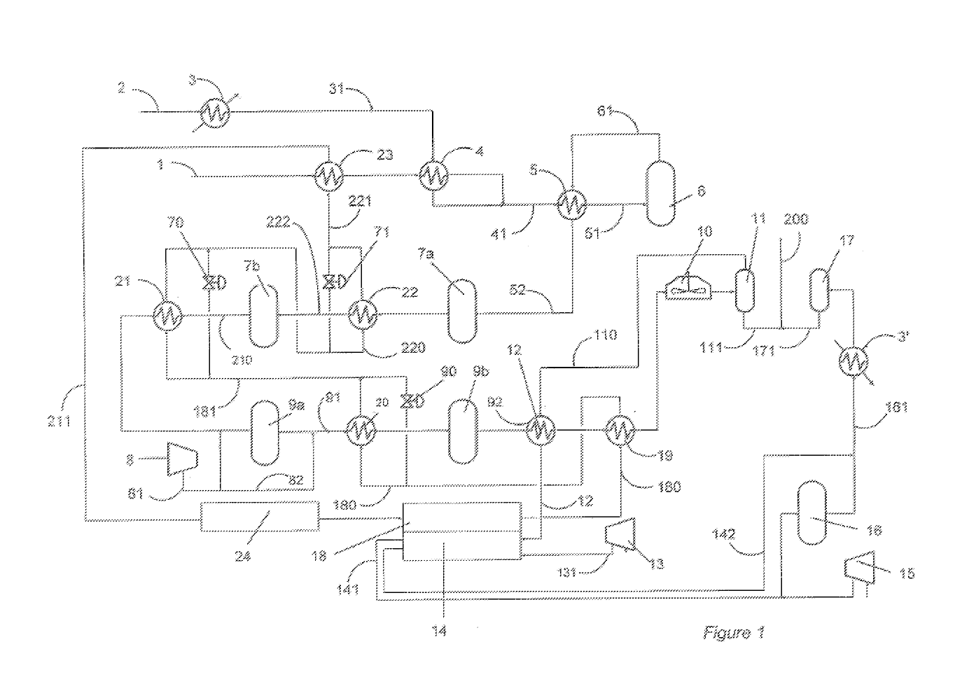

Other characteristics and advantages of the invention will be better understood and will emerge more clearly from reading the description given below, with reference to the accompanying FIG. 1, provided by way of example and diagrammatically showing the process for co-generation of heat and mechanical or electrical energy according to the invention.

This invention consists of an autonomous device for co-generation of mechanical or electrical energy and heat.

This device combines a fuel reformer with a unit for converting the gas that is produced into electrical or mechanical energy.

The fuel reformer that is used within the framework of the invention is a conventional reformer that is well known to one skilled in the art. It is the primary reactor of the reforming system. It is supplied with fuel in gaseous form and in water and/or air. The reaction is done with a catalyst that is selected based on the type of fuel that is used and the reforming technique. There are actually at least two reforming techniques according to the mixing at the inlet:

Vaporeforming: the fuel reacts with water,

Autothermal reforming: the fuel reacts with water and air.

The technique that is selected depends on the treated feedstock. According to one preferred embodiment of the invention, the technique that is used is vaporeforming. The advantage of the vaporefoming is that it does not require dilution with air.

The fuel that supplies the unit for converting the gas that is produced into electrical energy is hydrogen. This hydrogen is itself obtained from a fuel that puts out little or no pollution and is inexpensive and easily transportable: for example, a liquid hydrocarbon, and in particular ethanol, or any other type of liquid fuel that is well known to one skilled in the art, such as gasoline, diesel or else liquefied petroleum gas (LPG). In addition, for the sake of preserving the best carbon balance possible for the installation, this fuel can be obtained from the biomass, such as, for example, bioethanol. This fuel is transformed in-situ into hydrogen by reforming to supply the gas conversion unit that is produced into electrical energy without a storage stage. This device can thus be used in an isolated environment.

The unit for converting the gas that is produced into electrical or mechanical energy that is used within the framework of the invention can be an internal combustion engine that is linked to a device for producing electricity (such as, for example, an alternator), a turbine that is linked to an electricity-producing device, or else a fuel cell, and, for example, a fuel cell with a polymer membrane electrolyte. The fuel cell makes it possible to transform the chemical energy into electrical or mechanical energy directly.

The autonomous nature of the device according to the invention is ensured in particular by the fact that it is not necessary to supply the device with water because this invention comprises a system for recycling water that is implemented with means for recycling water. The recycling of water is carried out at the outlet of the reformer, which promotes the yield of the cell by concentration of the hydrogen, at the outlet of the cell, and, optionally, if the reformer technology under consideration allows it, at the outlet of the hydrogen burner that can be integrated into the reactor or that is independent of the reactor. If a burner that uses the hydrogen that is not consumed by the cell is present, the fact of condensing the water upstream improves its yield by concentrating the fuel, i.e., the hydrogen. The primary difficulty, in particular in the case where it is desired to develop an effective solution in a large variety of environments, even in hot climates, while respecting the desire to be self-sufficient, i.e., to have only fuel to supply to the system, is to identify in the process diagram cold sources that make it possible to condense the water. This invention, by an advanced thermal integration between the fuel-producing system, the unit for converting fuel into heat and electricity, and the thermal regulation network, proposes a process diagram and operating conditions that make it possible to address these problems.

This device can thus operate in temperate regions (daily temperature around 10° C.) as in hot regions (daily temperature that can reach 40° C.). This operability under different conditions is ensured by an innovation of this invention that consists in using the thermal regulation flow that is co-generated as a cold source for precooling the fluids of the process and occasionally as a hot source. The final cooling and the condensation are ensured by the reheating and the evaporation of the sources of fuel, water and air as well as by cooling with air during supply or finishing.

Another specific feature of the invention is to combine the reformer and the conversion unit in the production of heat, whereby the latter is recovered, for example, in the form of a water network that is used in the thermal regulation of the system.

### BRIEF DESCRIPTION OF THE DRAWINGS

A variant of the operation of the process according to this invention is illustrated in FIG. 1. FIG. 1 shows a process diagram that is based on this invention and that consists in co-generating heat, used next by a low-temperature thermal regulation network (<90° C.) and the mechanical or electrical energy from ethanol by means of a vaporeformer. The vaporeformer is followed by a chain for purification of hydrogen that consists of two high- and low-temperature reaction stages for conversion of carbon monoxide into water (WGS for Water Gas Shift according to English terminology), followed by two preferred oxidation stages of carbon monoxide into carbon dioxide. The presence of this purification chain is made necessary for lowering the carbon monoxide content in the effluent of the reformer to contents that can be accepted by the fuel cell (PAC) with an ion exchange polymer membrane (Polymer Electrolyte Membrane, PEM). The special feature of these PEM cells is to comprise a polymer electrolyte, Nafion® type, whose ion exchange function is ensured only when the latter is saturated with water.

According to another variant of the invention, not shown in FIG. 1, when the conversion unit that is used in the process is not a cell, but, for example, a combustion engine or a turbine, the purification chain is no longer necessary. The process thus does not comprise a purification stage. The flow (52) that comes from the vaporeformer in this case passes into the engine or turbine without passing through the purification unit.

The feedstock that is sent to the vaporeformer (6) consists of ethanol that circulates in the ethanol intake pipe (1) and water that circulates in the water intake pipe (2). The water is evaporated, at a first heat exchanger (3, 3′), upon contact of the burner smoke (16) after the latter has provided heat to the vaporeformer (6). In FIG. 1, the burner is placed separated from the exchangers or the vaporeforming reactor, but it is possible that the unit is in the reactor-exchanger form with an integrated hydrogen burner. The water then circulates in the evaporated water pipe (31). In parallel, the ethanol is preheated upon contact with a hot fluid that arrives via a first pipe (221) that comes from the cooling circuit (18) via a second heat exchanger (23) to then be evaporated upon contact with the hot vapor that circulates in the evaporated water pipe (31) via a third heat exchanger (4). The water-ethanol mixture that circulates in the water-ethanol pipe (41) is superheated at a fourth heat exchanger (5) by the vaporeformer effluents (6) that circulate in the pipe (61) coming from the vaporeformer (6) before entering via the pipe (51) that comes into the vaporeformer. The water-ethanol feedstock is converted at high temperature in the vaporeformer (6) into a synthetic gas, circulating in the pipe (61) that comes from the vaporeformer (6), rich in hydrogen and comprising a certain quantity of carbon monoxide. This quantity depends on the treated feedstock and operating conditions (temperature, pressure, vapor/carbon ratio) that the composition of the effluent determines in thermodynamic equilibrium. For example, in the case of ethanol with a reformer that operates at 750° C. at 0.42 MPa with a vapor to carbon ratio of 2.2, there is a composition of 49% H₂, 12% CO, and 29% H₂O for the majority products. The conversion reaction is endothermic; the necessary heat is provided by the burner (16) of hydrogen or synthetic gas that is not converted by the cell. The hot synthetic gas is cooled, under the conditions of the high-temperature carbon monoxide conversion reaction (WGS HT), i.e., at 300° C., which takes place in a first reactor (7a), by the evaporated feedstock that circulates in the water-ethanol pipe (41) for lowering a first time the carbon monoxide content of the synthetic gas that circulates in the pipe (52) coming from the fourth heat exchanger (5). The WGS HT reaction is exothermic; the effluent of the WGS HT reaction is cooled at a fifth heat exchanger (22) by the effluent that circulates in the pipe (220) coming from a sixth heat exchanger (21) to be under the conditions of the low-temperature carbon monoxide conversion reaction (WGS BT), i.e., at 150° C., which takes place in a second reactor (7b). The WGS BT reaction is exothermic; the effluents of the WGS BT reaction circulating in the pipe (210) coming from the second reactor (7b) are cooled by the hot fluid that circulates in a second pipe (181) that comes from the secondary cooling circuit (18) at the sixth heat exchanger (21). The reactors (7a, 7b) can, for example, be in a fixed bed, with, for example, the catalyst fixed on a ceramic monolith for reducing pressure drop. The WGS reaction is not adequate for lowering the specifications of carbon monoxide of all of the PEM fuel cells (PAC PEM); preferred oxidation stages are therefore then initiated in a first preferred oxidation reactor (9a) and in a second preferred oxidation reactor (9b) to lower the carbon monoxide content of the hydrogen-rich synthetic gas as much as possible. The preferred oxidation is implemented upon contact with a catalyst in the presence of air that comes through the pipe (81, 82) that comes from the compressor (8). With the reaction being exothermic, the effluent that circulates in the pipe (91) that comes from the first preferred oxidation reactor (9a) is cooled by a seventh heat exchanger (20) by the hot fluid that circulates in the pipe (180) that comes from the secondary cooling circuit (18). A second preferred oxidation stage that is implemented in the second preferred oxidation reactor (9b) completes the treatment of the oxidation of the carbon monoxide. The effluent that circulates in the pipe (92) that comes from the second preferred oxidation reactor (9b) is itself also cooled:
A first time at an eighth heat exchanger (12) by the cooled, water-poor synthetic gas, circulating in the pipe (110) that comes from the flash reactor (11) that it brought to the working temperature of the cell,
A second time at a ninth heat exchanger (19) by the fluid that circulates in a third pipe (180) that comes from the secondary cooling circuit (18).

The cooling is therefore done in two stages: a first stage at the eighth heat exchanger (12) and a second stage at the ninth heat exchanger (19).

A cooling-tower system (10) that is arranged after the ninth heat exchanger (19) executes a last cooling for the purpose of adequately cooling the purified synthetic gas that circulates in the pipe (92) that comes from the second preferred oxidation reactor (9b) to recover the water by simple flash in the flash reactor (11). The dehydrated gas that circulates in the pipe (110) that comes from the flash reactor (11) is then heated by the effluent that circulates in the pipe (92) that comes from the second partial oxidation reactor (9b). The PAC (14) is thus supplied by the compressed air at the pressure of the process, circulating in the pipe (131) that comes from the compressor (13), and by the dehydrated synthetic gas, circulating in the pipe (121) that comes from the eighth heat exchanger (12). The PAC (14) thus produces electrical energy and heat. The heat is evacuated by the secondary cooling circuit (18) to the thermal regulation network that is formed by the pipes (180, 181 and 221).

To operate, the PAC (14) consumes a portion of the hydrogen of the synthetic gas and the oxygen of the air. The result is water that is found in the gaseous state in the effluents of the cell. The gaseous effluent that contains hydrogen that is not consumed by the cell, circulating in the first pipe (141) that comes from the cell (14), is sent into a burner (16) that provides energy to the vaporeformer (6). The effluent that circulates in the pipe (161) that comes from the burner (16) is then reunited with the oxygen-poor gaseous effluent of the cell, circulating in the second pipe (142) that comes from the cell (14) to be condensed by the water (2) of the feedstock and thus to recover the water by simple flash in the flash reactor (17). The condensed water that circulates in the pipes (111 and 117) coming reciprocally from the flash reactors (11 and 17) is recycled (200) at the inlet of the system by the pipe (2) and is adequate for the operation of the unit, ensuring the self-sufficiency in water of the system.

With regard to the thermal regulation network formed by the pipes (180, 181 and 221), it comes from the secondary cooling circuit (18) at the temperature of the process. In a first step, it is used as a cold source to ensure the intermediate cooling on the effluent of the partial oxidation via the ninth heat exchanger (19). The fact of using the thermal regulation network as a cold source has the advantage that each stage contributes to supplying the heat network such as the stages (20), (21) and (22). For each of these stages, what is important is to regulate the temperature of the thermal regulation gas based on the heat that it is desired to tap. This modulation is made possible by the presence of by-passes (70, 71 and 90) that make it possible to bypass the heat exchangers (20), (21) and (22) completely or partially. The thermal regulation network is used as a hot source for preheating the ethanol feedstock that circulates in the pipe (1) by means of the second heat exchanger (23), and then exits from the process by circulating in the pipe (211) that comes from the second heat exchanger (23) to the user (24) that will consume the heat, for example in a domestic or industrial heating system, such as for the drying of wood. The user restores the flow of the thermal regulation network cooled in the process at the secondary cooling circuit of the cell.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The following examples illustrate this invention.

### EXAMPLES

### General Presentation of the Process that is Used in the Examples

An ethanol reformer that is combined with a fuel cell for the purpose of implementing the co-generation of heat and electricity is considered.

The unit is sized for the production of 5 electric kilowatts (kWe); the production of heat expressed in thermal kilowatts (kWth) is implemented on the secondary cooling circuit of the fuel cell or is implemented according to the preferred embodiment both on the secondary cooling circuit of the cell and on the excess locations of heat of the reforming process. Actually, the reforming reaction is endothermic; it takes place at high temperature and makes possible the recovery of heat in the cooled smoke. Furthermore, the process comprises exothermic reactions such that the reactions for conversion of carbon monoxide and the reactions for partial oxidation do not require keeping the temperature within a window that is limited by the ranges of operation of the catalysts of the reactions for conversion of carbon monoxide; this provides a higher-temperature heat than the one for operating the cell, and it is this that makes the integration advantageous.

Regardless of the example under consideration, the production of the hydrogen that is necessary to the production of 5 kWe by the cell corresponds to a consumption of 1.4 kg/h of ethanol. In the same way, 2.46 kg/h of water is to be supplied for converting this flow of ethanol into synthetic gas.

The composition of the hydrogen-rich synthetic gas at the outlet of the reformer:

| Compound | Molar Fraction |
|---|---|
| H₂O | 0.177 |
| N₂ | 0.018 |
| CO₂ | 0.205 |
| H₂ | 0.596 |
| CH₄ | 0.004 |

In this flow, water is condensed at a temperature of 10° C. above the ambient temperature in the case where it is cooled only with a cooling tower (A1) or at 5° C. above the ambient temperature in the case where the cooling of the synthetic gas is carried out both by the thermal regulation network, a cooling tower (A2) and an exchange with the liquid feedstock that is still not introduced into the system and that is itself, like ambient air, also considered to be at ambient temperature.

The water-poor and hydrogen-rich gas (H₂) is sent to the cell as a fuel. Not all of the hydrogen is consumed. The remaining hydrogen is sent into a burner for providing heat to the vaporeforming. The water that is produced in the cell and in the burner can be recycled, either by means of a simple cooling tower (B1) or by means of a cooling tower (B2) that follows the heating and the evaporation of the water that is introduced at the inlet of the reformer by combustion smoke.

The two possibilities with and without integration of the reformer in the heating-cooling network are presented respectively in Examples 1 and 2.

### Example 1

### For Comparison

Co-generation device combining an ethanol reformer and a PEM-type fuel cell without integration of the reformer in the thermal regulation network.

### Electrical Balance

Quantity of electricity produced by the cell: 4.97 kWe

Self-consumption of the unit: 1.08 kWe

Net electrical production: 3.89 kWe

### Thermal Balance

Heat that can be recovered on the secondary cooling circuit of the cell, or the heat that is recovered such that the water of the secondary cooling circuit leaves the cell at 85° C. and returns after recovery of the heat at 80° C.

Recoverable heat: 3.31 kWth

Thermal exchange at the cooling towers (air at 40° C.):

Cooling Tower A1: 0.756 kW

Cooling Tower B1: 3.09 kW

Quantity of recyclable water: in this case, 2.44 kg/h of water is recycled at 40° C.

### Example 2

### According to the Invention

Device for co-generation combining an ethanol reformer and a PEM-type fuel cell with integration of the reformer in the thermal regulation network, according to the invention.

### Electrical Balance

Quantity of electricity produced by the cell: 4.97 kWe

Self-consumption of the unit: 1.08 kWe

Net electrical production: 3.89 kWe

### Thermal Balance

Heat that can be recovered on the secondary cooling circuit of the cell, or the heat that is recovered such that the water of the secondary cooling circuit leaves the cell at 85° C. and returns after recovery of the heat at 80° C.

Recoverable heat: 3.96 kWth

Thermal exchange at the cooling towers (air at 40° C.):

Cooling Tower A2: 0.640 kW

Cooling Tower B2: 1.34 kW

Quantity of recyclable water: in this case, 2.84 kg/h of water is recycled at 40° C.

The integration of the reformer in the example according to the invention results in a gain in the thermal energy that is recovered of up to 19% relative to the example that does not integrate the reformer as a heat source for the system. In addition, the quantity of recycled water is greater by 15% than the amount of water that is necessary for the good operation of the unit when the diagram described by the invention is complied with. Finally, it is noted that the energy to be dissipated on the cooling tower B2 is clearly less than that dissipated in B1.

This invention should not be limited to the details provided above and makes possible embodiments in numerous other specific forms without being removed from the field of application of the invention. Consequently, these embodiments should be considered by way of illustration and can be modified without, however, leaving the scope defined by the accompanying claims.

The entire disclosures of all applications, patents and publications, cited herein and of corresponding French application Ser. No. 10/01754, filed Apr. 23, 2010 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1) Process for the production of electrical or mechanical energy and heat from a liquid fuel that comprises:
A stage for producing a synthetic gas by vaporeforming in a vaporeforming unit (6) that uses liquid fuel and water, with the heat that is necessary to this stage being provided by a hydrogen burner (16) and by the synthetic gas that is produced,
A stage for dehydrating synthetic gas by condensation of the water that is contained in the gas,
A stage for transforming dehydrated synthetic gas into electrical energy and into heat,
A stage for recycling unconverted synthetic gas to the synthetic gas transformation stage to a hydrogen burner (16) that supplies energy to the vaporeforming unit (6),
A stage for recycling the condensed water that is obtained during the dehydration of the synthetic gas to the vaporeforming unit (6).

2) Process for the production of electrical or mechanical energy and heat according to claim 1, in which the synthetic gas transformation stage produces an oxygen-poor gaseous effluent that is condensed to obtain water.

3) Process for the production of electrical or mechanical energy and heat according to claim 2, in which the water that is obtained by condensation of the oxygen-poor gas effluent is recycled to the vaporeforming unit (6).

4) Process for the production of electrical or mechanical energy and heat according to claim 1, in which the burner produces a gaseous effluent that is condensed for obtaining water.

5) Process for the production of electrical or mechanical energy and heat according to claim 4, in which the water that is obtained by condensation of the gaseous effluent is recycled to the vaporeforming unit (6).

6) Process for the production of electrical or mechanical energy and heat according to claim 1, in which the dehydration stage is implemented by a cooling-tower system (10).

7) Process for the production of electrical or mechanical energy and heat according to claim 1 comprising a stage for purification of the synthetic gas that is obtained in the vaporeforming stage.

8) Process for the production of electrical or mechanical energy and heat according to claim 7 in which the stage for purification of the synthetic gas comprises:
A high-temperature carbon monoxide to water conversion reaction,
A low-temperature carbon monoxide to water conversion reaction,
At least a first preferred oxidation stage of the carbon monoxide that is contained in the synthetic gas into carbon dioxide.

9) Process for the production of electrical or mechanical energy and heat according to claim 7, in which the purification stage comprises a second stage of preferred oxidation of the carbon monoxide that is contained in the synthetic gas into carbon dioxide.

10) Process for the production of electrical or mechanical energy and heat according to claim 1, in which the purified synthetic gas transformation stage is implemented with a fuel cell (14).

11) Process for the production of electrical or mechanical energy and heat according to claim 1, in which the synthetic gas dehydration stage is preceded by a synthetic gas cooling stage.

12) Process for the production of electrical or mechanical energy and heat according to claim 1, in which the cooling stage is implemented in two stages:
A first stage at the level of a heat exchanger (12) by the dehydrated synthetic gas, circulating in a pipe (110) that comes from a flash reactor (11),
A second stage at the level of another heat exchanger (19) by a fluid, circulating in a pipe (180) that comes from the secondary cooling circuit (18).

13) Process for the production of electrical or mechanical energy and heat according to claim 9, comprising a synthetic gas cooling stage that is implemented between the first and the second preferred oxidation stages of the carbon monoxide that is contained in the synthetic gas into carbon dioxide.

14) Process for the production of electrical or mechanical energy and heat according to claim 8, in which the synthetic gas that is obtained from the high-temperature carbon monoxide to water conversion reaction is cooled, at the level of a heat exchanger (22), by an effluent that circulates in a pipe (220) that comes from another heat exchanger (21) to be under the conditions of the low-temperature carbon monoxide to water conversion reaction.

15) Process for the production of electrical or mechanical energy and heat according to claim 8, in which the synthetic gas that is obtained from the low-temperature carbon monoxide to water conversion reaction is cooled, at the level of a heat exchanger (21), by a hot fluid that circulates in a second pipe (181) that comes from the secondary cooling circuit (18).
